(19) United States
(12) Patent Application Publication
(10) Pub. No.: US 2007/0244607 A1
(43) Pub. Date: Oct. 18, 2007

(54) Multifunctional automotive remote control unit

(76) Inventor: Yueh-Ying Ko, Banciao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/405,411

(22) Filed: Apr. 18, 2006

(51) Int. Cl. G06F 19/00; G05D 1/00

(52) U.S. Cl. 701/2; 701/29; 340/442

(57) ABSTRACT

A multifunctional automotive remote control unit includes a housing and a bilateral control circuit positioned within the housing. The housing includes a plurality of operating keys and a LCD display that are electrically coupled to the bilateral control circuit, and one of the operating keys serves as a control key for choosing a desired function. In addition to the circuit required by the automotive remote control unit, the bilateral control circuit further includes a signal-receiving unit for receiving signals transmitted by the tire pressure detector on the tire and then transmitting the received signals to a microprocessor for further processing, thereby displaying the tire pressure value on the LCD display 13 and giving out a warning signal in case of abnormal tire pressure so that a tire pressure displaying and warning unit is created. The remote control unit can be switched as desired by the driver between the automotive remote control unit and the tire pressure displaying and warning unit by use of the control key. In this way, the tire pressure displaying and warning functions are integrated in a body without increasing the whole volume. Accordingly, the cost can be reduced while a convenient use is ensured.

### BACKGROUND OF THE INVENTION

1. Field of the Invention

The invention relates to a multifunctional automotive remote control unit, and more particularly to a remote control unit in which an automotive remote control unit and a tire pressure displaying and warning unit are integrated.

2. Description of the Related Art

The conventional automotive remote control units can be divided into general one-way remote controllers and two-way interactive remote controllers. The automotive remote control unit includes substantially functions of locking and unlocking the car doors as well as the warning effect.

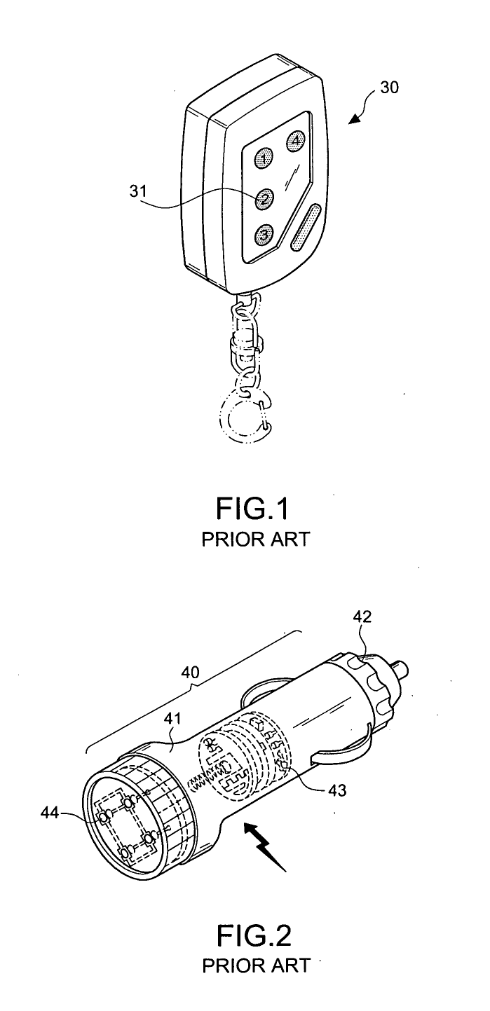

As shown in FIG. 1, a conventional automotive remote control unit 30 has several operating keys 31 on a panel thereof. The locking/unlocking functions of the car doors can be controlled by the operating keys 31. Meanwhile, a locking function can be fulfilled in case that the alarm sounds.

A pressure relief of the tires of the car can arise when the car is subject to the temperature rise due to exposure to sun radiation and temperature drop at night. As a result, the tire pressure can be lower than the normal value of 28 psi., thereby causing a risk involved in the driving safety. Even, it is hard to imagine when the tires are burst due to the insufficient tire pressure during the driving process.

Regarding the driving tire pressure detecting and warning apparatuses, the applicant of the invention has disclosed an “automotive tire pressure detecting and warning apparatus” (Appl. No. 93118466). As shown in FIG. 2, a tire pressure receiving unit 40 is installed within the cigar lighter socket in the car. The tire pressure receiving unit 40 includes a housing 41, a plug 42, and a receiving circuit 43. In case of insufficient tire pressure, a tire pressure detector installed at a certain place of the car tires will transmit warning signals to the tire pressure receiving unit 40. Thereafter, the light-emitting diodes 44 light up to show that something is wrong with the tire pressure. Accordingly, the drive can take preventive measure to ensure the driving safety.

In view of the aforementioned designs, the functions of the conventional automotive remote control unit 30 are limited in locking/unlocking car doors as well as giving out warning signals. Meanwhile, the tire pressure receiving unit 40 of the tire pressure detecting and warning apparatus has to be fixed within the cigar lighter socket in the car. Meanwhile, it has a greater volume and thus occupies a certain space within the car. Therefore, the whole appearance within the car is easily destroyed. Even, the operation of the gearshift lever will be considerably affected. Moreover, the tire pressure is unknown when the driver gets off the car or when the car is not used for a certain period. The driver learns about the tire pressure only when he starts the car and stays in the car. Thus, the safety risk in driving still has to be taken into account and improved.

Although the automotive remote control unit and the tire pressure detecting and warning apparatus of the prior art can reach certain functions and merits, the applicant of the invention hopes that the following functions and effects can be achieved.
1. Both the automotive remote control unit and the tire pressure detecting and warning apparatus can be combined in one product;
2. Lightweight;
3. A convenient carrying;
4. At any time, the driver is able to learn about the tire pressure; and
5. The design can achieve the economic benefit of reducing cost.

### SUMMARY OF THE INVENTION

A primary object of the invention is to provide a multifunctional automotive remote control unit in which an automotive remote control unit and a tire pressure displaying and warning unit are integrated without increasing the whole volume of the original automotive remote control unit.

Another object of the invention is to provide a multifunctional automotive remote control unit that can reduce the cost and ensure the convenient application.

A further object of the invention is to provide a multifunctional automotive remote control unit with which the tire pressure can be realized at any time and a convenient carrying can be ensured.

In order to achieve the above-mentioned objects, a multifunctional automotive remote control unit comprises:

a) a housing adapted to permit a convenient carrying for the driver; and

b) a bilateral control circuit positioned within the housing for a remote control of an automotive central control module within a car, thereby achieving an interactive transmission and confirmation of signals so that an automotive remote control unit is created,

wherein the housing includes a plurality of operating keys and a LCD display that are electrically coupled to the bilateral control circuit, and one of the operating keys serves as a control key for choosing a desired function;

wherein, in addition to the circuit required by the automotive remote control unit, the bilateral control circuit further includes a signal-receiving unit for receiving signals transmitted by the tire pressure detector on the tire and then transmitting the received signals to a microprocessor for further processing, thereby displaying the tire pressure value on the LCD display and giving out a warning signal in case of abnormal tire pressure so that a tire pressure displaying and warring unit is created; and

wherein the remote control unit can be switched as desired by the driver between the modes of the automotive remote control unit and the tire pressure displaying and warning unit by use of the control key.

### BRIEF DESCRIPTION OF THE FIG.S

The accomplishment of this and other objects of the invention will become apparent from the following descriptions and its accompanying figures of which:

FIG. 1 is a perspective view of a conventional automotive remote control unit;

FIG. 2 is a perspective view of a conventional tire pressure detector;

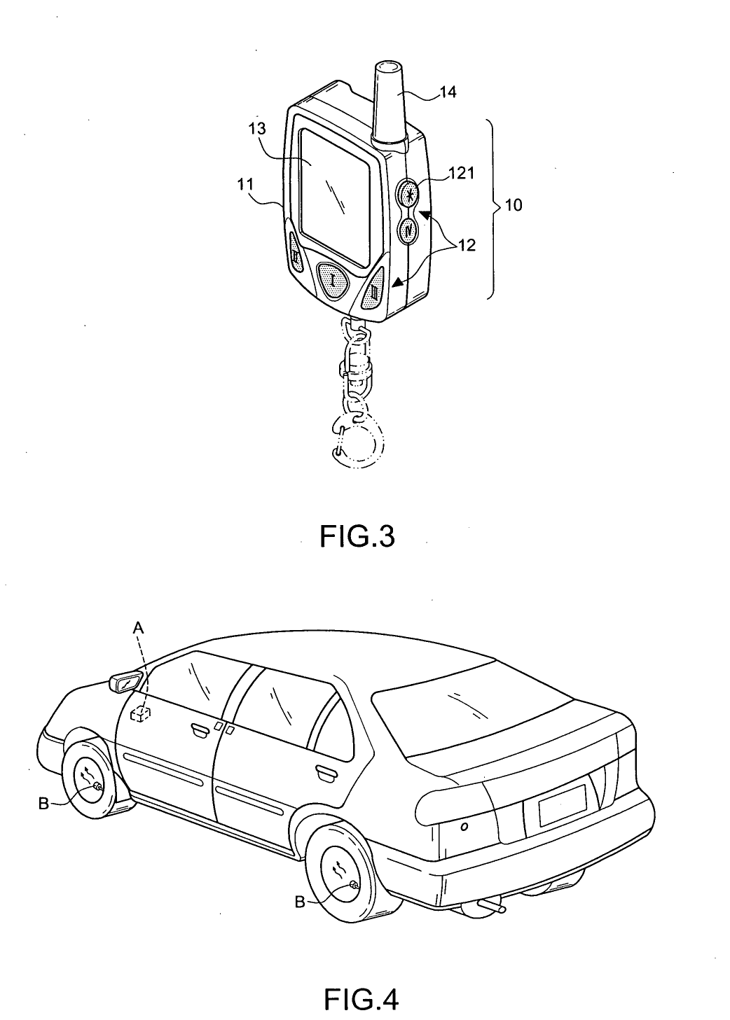

FIG. 3 is a perspective view of a multifunctional automotive remote control unit in accordance with the invention;

FIG. 4 is a perspective view of an automotive central control module and a tire pressure detector in accordance with the invention that are fitted in a car;

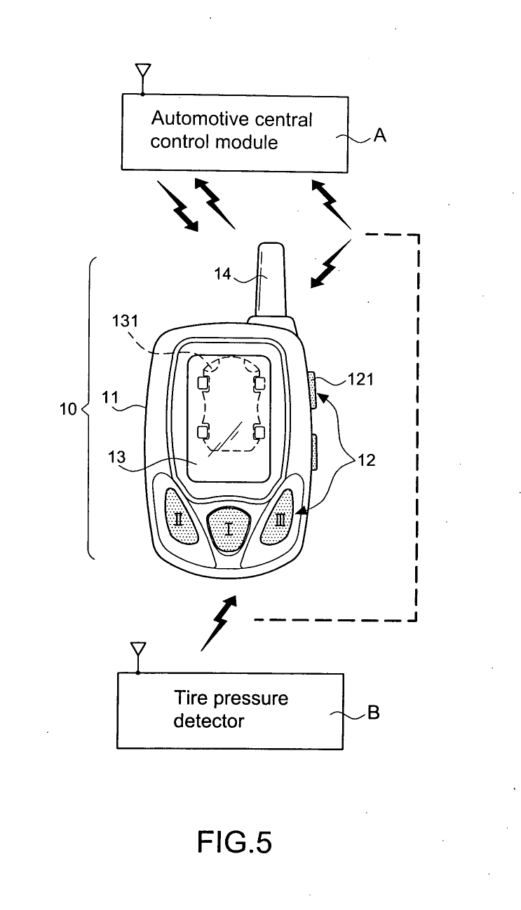

FIG. 5 is an application view of the multifunctional automotive remote control unit in accordance with the invention; and

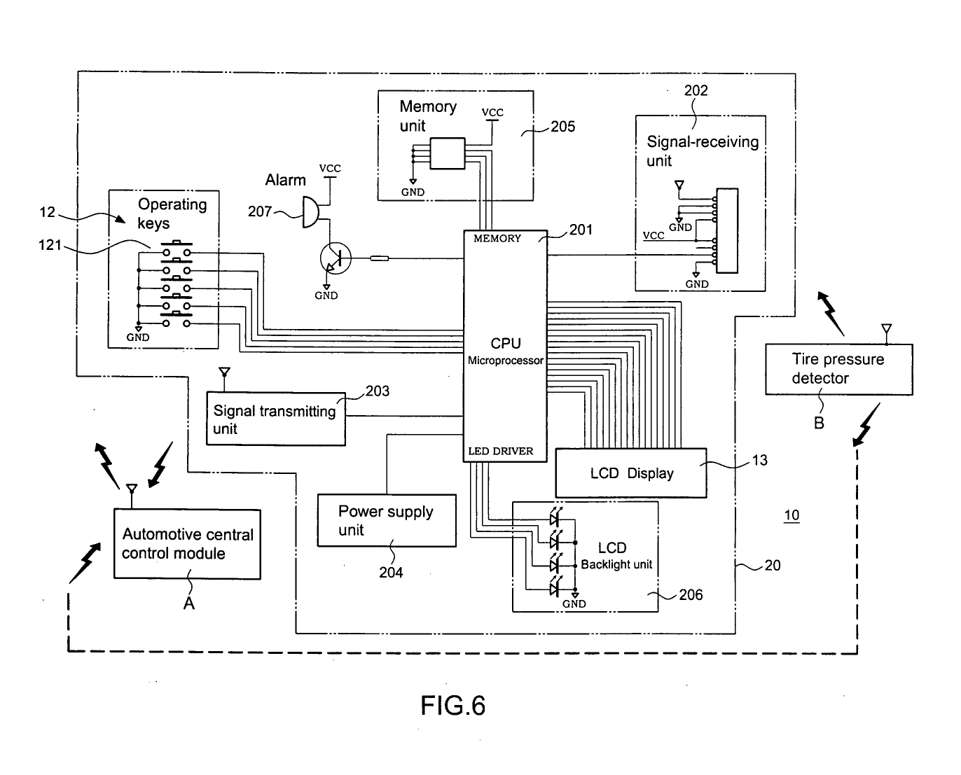

FIG. 6 is a circuit diagram of the bilateral control circuit in accordance with the invention.

### DETAILED DESCRIPTION OF THE PREFERRED EMBODIMENT

First of all, referring to FIG. 3, a multifunctional automotive remote control unit 10 in accordance with the invention combines the basic functions of the conventional automotive remote control unit and the tire pressure warning unit together. The multifunctional automotive remote control unit 10 includes a housing 11, several operating keys 12, a control key 121, an LCD display 13, and a transmitting/receiving antenna 14. The housing 11 is so dimensioned that the multifunctional automotive remote control unit 10 is easy for the car driver to carry. In this way, the car driver can learn about the tire pressure no matter whether he is in the car or not.

As shown in FIG. 4, an automotive central control module (A) is installed at a certain place in the car while a tire pressure detector (B) is disposed at a certain place on the tires. When the tire pressure is not enough or has some problems, the tire pressure signal can be transmitted by a transmitting circuit of the tire pressure detector (B) to the remote control unit 10. The tire pressure detector (B) and the automotive central control module (A) belong to the prior art and are not objects of the invention so that no further descriptions thereto are given hereinafter.

Referring to FIG. 5, the housing 11 of the multifunctional automotive remote control unit 10 includes further a plurality of operating keys 12 and a LCD display 13 that are electrically coupled to a bilateral control circuit 20. One of the operating keys 12 serves as a control key 121 for choosing a desired function. The operating keys 12 can fulfill the functions of opening/closing doors and the antitheft functions. The control key 121 allows a practical switching between the modes of automotive remote control unit and the tire pressure warning unit.

As shown in FIG. 6, the bilateral control circuit 20 is disposed within the housing 11 for a practical remote control of the automotive central control module (A) within the car. The automotive central control module (A) permits a two-way function in transmitting and confirming the signals. Accordingly, an automotive remote control unit is created.

In addition to the circuit required by the automotive remote control unit, the bilateral control circuit 20 further includes a signal-receiving unit 202 for receiving signals transmitted by the tire pressure detector (B) on the tire and then transmitting the received signals to a microprocessor 201 for further processing. Thereafter, the tire pressure value can be displayed on the LCD display 13. Meanwhile, a warning signal can be given in case of abnormal pressure. In this way, a tire pressure warning unit is created. In addition to receiving the tire pressure signals, the signal-receiving unit 202 can also receive the confirmation signal returned by the automotive central control module (A). Of course, both of the receiving functions can be fulfilled by two different units (not shown).

Moreover, the bilateral control circuit 20 further includes:

a signal transmitting unit 203 coupled to the microprocessor 201 for transmitting the control signal produced by the microprocessor 201 to the automotive central control module (A) within the car;

a memory unit 205 coupled to the microprocessor 201 for storing data;

a backlight unit 206 coupled to the microprocessor 201 for providing backlighting source required by the LCD display 13, the backlight unit 206 consisting of the light-emitting diodes or the like;

an alarm for receiving the control signal produced by the microprocessor 201 and giving acoustic warning signals; and

a power supply unit 204 disposed within the housing 11 for supplying the required electric energy to the above-mentioned components during their operation.

The power supply unit 204 can be a normal AAA-battery. The transmitting/receiving antenna 14 of the signal-receiving unit 202 and the signal transmitting unit 203 can be mounted on the housing 11 for avoiding the transmitting/receiving blind spots.

Referring to FIGS. 4, 5, and 6, the automotive central control module (A) and the tire pressure detector (B) are positioned on the car. The remote control unit 10 is normally carried by the user. Since the tire pressure detector (B) is small and only has 2-3 cm big, the range of the transmitting signals amounts to about ten meters. To the contrary, the central control module (A) and the remote control unit 10 can receive signals over 1000 meters. As a result, the tire pressure detector (B) is located near the central control module (A). The farmost tire is only several meters far from the automotive central control module (A). Thus, the tire pressure detector (B) is able to transmit the tire pressure signal to the automotive central control module (A) first. Then, the transmitting unit within the automotive central control module (A) will transmit the tire pressure signal to the remote control unit 10. As a result, the driver who is situated at a remote place over 1000 meters can receive the tire pressure signal in addition to the bilateral remote control of the automotive central control module (A).

Based on the above-mentioned configuration, the tire pressure warning unit and the automotive remote control unit are integrated into one remote control unit 10, thereby achieving the convenient and safe operation. As shown in FIG. 5, the remote control unit in accordance with the invention can realize a practical interactive detection and confirmation with the automotive central control module (A). Meanwhile, a reliable reception of the confirmation signals and the warning signals produced by the central control module (A) can be ensured as well. Moreover, the signal figures or values can be displayed on the LCD display 13. At the same time, the remote control unit in accordance with the invention can be switched to the optical warning unit of the tire pressure detector (B) by use of the control key 121. For example, the figures 131 of the tires of the car appear on the LCD display 13 while the tire pressure values of different tires can be displayed by operation of the operating keys 12. In case of abnormal tire pressure value, the microprocessor 201 within the housing 11 can transmit control signals to the alarm 207 for giving out the warning sound or to the LCD display 13 for producing warning images or words. In this way, the driver can be warned in time to ensure a better driving safety.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A multifunctional automotive remote control unit, comprising:
a) a housing adapted to permit a convenient carrying for the driver; and
b) a bilateral control circuit positioned within the housing for a remote control of an automotive central control module within a car, thereby achieving an interactive transmission and confirmation of signals so that an automotive remote control unit is created,
wherein the housing includes a plurality of operating keys and a LCD display that are electrically coupled to the bilateral control circuit, and one of the operating keys serves as a control key for choosing a desired function;
wherein, in addition to the circuit required by the automotive remote control unit, the bilateral control circuit further includes a signal-receiving unit for receiving signals transmitted by the tire pressure detector on the tire and then transmitting the received signals to a microprocessor for further processing, thereby displaying the tire pressure value on the LCD display and giving out a warning signal in case of abnormal tire pressure so that a tire pressure displaying and warning unit is created; and
wherein the remote control unit can be switched as desired by the driver between the modes of the automotive remote control unit and the tire pressure displaying and warning unit by use of the control key.

2. The multifunctional automotive remote control unit as recited in claim 1 wherein the housing further includes a transmitting/receiving antenna.

3. The multifunctional automotive remote control unit as recited in claim 1 wherein the bilateral control circuit further includes:
a) a signal transmitting unit coupled to the microprocessor for transmitting the control signal produced by the microprocessor to the automotive central control module within the car;
b) a memory unit coupled to the microprocessor for storing data;
c) a backlight unit coupled to the microprocessor for providing backlighting source required by the LCD display;
d) an alarm for receiving the control signal produced by the microprocessor and giving acoustic warning signals; and
e) a power supply unit for supplying the required electric energy to the above-mentioned components during their operation.

4. The multifunctional automotive remote control unit as recited in claim 3 wherein the backlight unit consists of light-emitting diodes.

5. The multifunctional automotive remote control unit as recited in claim 3 wherein the power supply unit includes a battery disposed within the housing.

6. The multifunctional automotive remote control unit as recited in claim 1 wherein the tire pressure detector is mounted on the tires of the car and includes a transmitting circuit for transmitting the tire pressure signal to the remote control unit.

7. The multifunctional automotive remote control unit as recited in claim 6 wherein the tire pressure detector transmits the tire pressure signal to the automotive central control module while the transmitting unit of the automotive central control module (A) transmits the tire pressure signal to the remote control unit.
